(19) United States
(12) Patent Application Publication
(10) Pub. No.: US 2004/0160010 A1
(43) Pub. Date: Aug. 19, 2004

(54) Winner's card game

(76) Inventor: James Patrick Bowling, Seabrook, TX (US)

Correspondence Address: SCHUBERT & ASSOCIATES, 6013 CANNON MTN DR, S14, AUSTIN, TX, 78749, US

(21) Appl. No.: 10/368,538

(22) Filed: Feb. 18, 2003

(51) Int. Cl. G06F 17/00

(52) U.S. Cl. 273/294

(57) ABSTRACT

The invention disclosed provides a method and means for playing a card game comprising receiving bets, including second-chance bets, dealing at least one set of cards, identifying one or more winning bets in each set, and paying-off one or more of the winning bets in each set. The invention also comprises an apparatus for playing a card game. The apparatus comprises a playing surface comprising a betting area, an open area, and a payoff area, wherein the open area is located between the betting area and the payoff area. The betting area comprises a plurality of player betting areas, wherein each of the plurality of player betting areas further comprises representations of three winning combinations. The payoff area comprises enlarged representations of the three winning combinations. Finally, the invention provides a real and virtual (i.e., computerized) version of the card game.

### BACKGROUND OF THE INVENTION

Wagering games utilizing cards abound. One example is Caribbean Stud. In this game, based on 5 Card Stud (i.e., a kind of poker), players ante, and five cards are dealt to the players and then to the dealer. All cards are dealt face-down except for the fifth card dealt to the dealer. Based on this fifth card, players decide whether to fold, because they feel they cannot beat the dealer's hand, or double their ante (i.e., a “call bet”), because they feel they can beat the dealer's hand. The dealer then turns over the remaining four cards. If the dealer does not have at least an ace and king, then the dealer cannot “open,” and all players who did not fold win their ante. Their call bets are simply returned. If the dealer can “open,” then a player's hand must beat the dealer's hand in order to win the call bet and have the ante simply returned; if the player's hand does not beat the dealer's hand, then the player loses both the ante and call bet.

Another popular card game is Let It Ride. Also based on 5 Card Poker, Let it Ride begins by players betting three equal bets in each of their three betting areas often denoted “bet $,” “bet 1,” and “bet 2.” The players and the dealer then receive three cards, face-down, and the dealer immediately discards one of the dealer's three cards. Then, the players pick up their cards, and decide whether they believe they have losing or winning poker hands. If losing, a player asks for “bet 1” back. If winning, then a player opts to “Let It Ride.” Now, the dealer turns over one of the dealer's two face-down cards (“the up card”). Using this up card and the players' own three cards, each player makes the best poker hand they can with these four cards. A second round then begins.

With these four cards, each player is permitted to Let It Ride or ask for bet “2” back. The dealer turns over the other one of the dealer's face-down cards (“the second up card”). Using the up card and the second up card, each player makes the best poker hand they can with these five cards. Each player is a winner that has a poker hand of a pairs of tens or better. Winning players are paid off according to their remaining bets, which, at a minimum, must include the “$ bet.” All losing bets are collected after the second round is complete.

Still another popular card game is “Three Card Poker.” In this game, three cards are dealt face-down to each player, followed by a first betting round. Upon a player opening this first betting round, each and every other player must call or raise to stay in the game. Those players staying in the game now draw another two cards and then engage in a second betting round. The winner is the player with the best poker hand made from choosing three cards from the five cards in the player's hand. Three-of-a-kind (in particular, three aces) is the best possible poker hand.

With these games and others, the mere possibility of winning a wager is often not enough to maintain players' interest. Many people avoid these games because of their slow pace; they find the learning of the game rules too time consuming. Further, the game rules actually vary from one casino to another, or the player is playing against other players, other players and the house, or just the house. As a result, many novice players are reluctant to play these games because of onerous efforts required to understand the risks.

A need, therefore, exists for a fast-paced and easily understood game, where the player plays against no one and always wins a wager.

### BRIEF SUMMARY OF EXAMPLE EMBODIMENTS

According to one at least one example embodiment, a method of playing a card game is provided. The method comprises receiving bets, dealing at least one set of cards, identifying one or more winning bets in each set, and paying-off one or more of the winning bets in each set.

In a further example, a system is provided for playing a card game. In at least one example, the system comprises a means for receiving bets, a means for dealing at least one set of cards, a means for identifying one or more winning bets in each set, and a means for paying-off one or more of the winning bets in each set.

In yet a further example, an apparatus is provided for playing a card game. The apparatus comprises a playing surface comprising a betting area, an open area, and a payoff area, wherein the open area is located between the betting area and the payoff area. The betting area comprises a plurality of player betting areas, wherein each of the plurality of player betting areas further comprises representations of three winning combinations. And, the payoff area comprises enlarged representations of the three winning combinations.

Still further examples provide an apparatus for, a method of, and/or a system of playing a real or virtual (i.e., computerized) version of the card game.

### BRIEF DESCRIPTION OF THE DRAWINGS

FIG. 1 is a plan view of an example embodiment of the invention.

FIG. 2 is a plan view of a further example of the invention.

FIG. 3 is a plan view of another example of the invention.

FIG. 4 is a flowchart of a method useful according to an example of the invention.

FIG. 5 is a schematic according to an example of the invention.

FIG. 6 is a schematic according to a further example of the invention.

FIG. 7 is a schematic of yet another example of the invention.

FIG. 8 is a flowchart of an example of the invention.

FIG. 9 is a flowchart of yet another example of the invention.

### DETAILED DESCRIPTION OF EXAMPLE EMBODIMENTS

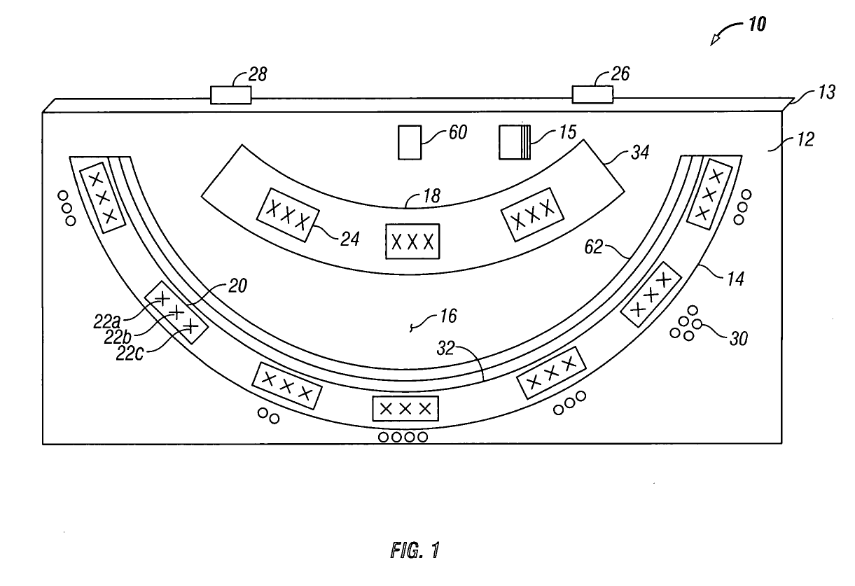

First with reference to FIG. 1, an apparatus 10 for a card game is seen. The apparatus 10 comprises a playing surface 12 having a betting area 14, an open area 16, and a payoff area 18. The open area 16 is located between the betting area 14 and the payoff area 18, and is the primary area for dealing a set of cards to each player upon play of the game.

The betting area 14 is made up of a plurality of player betting areas 20. In this manner, each player betting areas 20 has an individual betting area. Each of the player betting areas 20 also has representations 22 of three winning combinations 22a, 22b, 22c from a deal of a set to a player. In addition, the shape of the betting area 14 comprises a quasi-semi-circular arrangement 32. Other shapes are useful in other embodiments. For instance, in at least one alternative, the betting area 14 comprises a rectangular arrangement running alongside and in front of the edges of the playing surface 12. Other variations will occur to those of skill in the art.

Referring again to the example of FIG. 1, just as the player betting areas 20 have representations 22, so does the payoff area 18. In fact, the payoff area 18 comprises enlarged representations 24 of the three winning combinations 22a, 22b, 22c. In addition, the shape of the payoff area 18 comprises a quasi-semi-circular arrangement 34, but like the betting area 14, this shape is not required. The payoff area 18 could just as easily have a rectangular arrangement. Other variations will occur to those of skill in the art.

The actual size of the playing surface 12 is especially convenient for casinos. In one example embodiment, the playing surface 12 has the size of the top surface of a black jack table, and in another, a pai gow table. Other variations departing in size from these standard casino tables will occur to those of skill in the art.

In another example, the apparatus 10 comprises have a drop box 26 and/or a tip box 28 attached to the side 13 of the playing surface 12. Variations in placement of a drop box 26 or a tip box 28 will occur to those of skill in the art, and these variations do not depart from this invention.

Playing cards 15 used with the apparatus 10 comprise one or even ten decks of standard playing cards 15 with inclusion of the jokers being optional. However, play is suggested with two or more decks and no jokers for at least two reasons. One is to provide a sufficient number of playing cards for several players playing the game in a round. The other is that two decks still retains favorable and fair advantages for both the house and the players.

Wagering markers 30 used with the apparatus 10 are for disposal onto the playing surface 12. These wagering markers 30 represent a player's bets. These wagering markers 30 comprise currency, casino value chips, or some other thing used to represent an amount of bets.

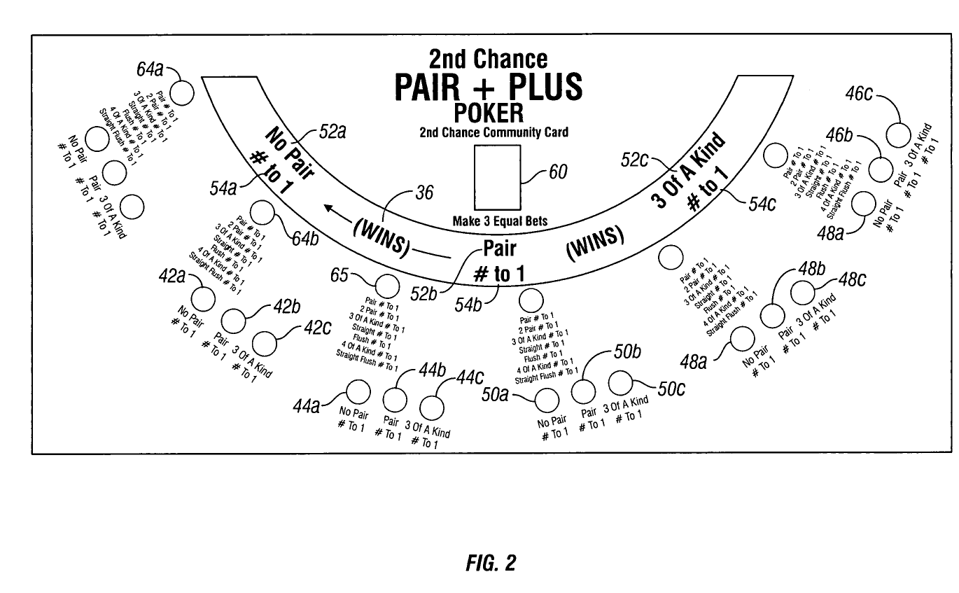

Turning now to FIG. 2, the representations 22 comprise three winning combinations 22a, 22b, 22c possible from a deal of at least three cards 15 to each player. In one example embodiment, the representations comprise three circles 42a, 42b, 42c, wherein each one of the three circles 42a, 42b, 42c is for a different one of the three winning combinations 22a, 22b, 22c. Circles are generally used as symbolic of where coins should go when bets are placed. Other shapes will occur to those of skill in the art without departing from the scope of this invention.

In additional and/or alternative embodiments, the representations 22 comprise three descriptive phrases 44a, 44b, 44c, wherein each one of the three descriptive phrases 44a, 44b, 44c is for a different of the three winning combinations 22a, 22b, 22c. Examples of the three descriptive phrases 44a, 44b, 44c include “No Pair,” “Pairs,” and “Three of a Kind.”

Finally, in still another and/or alternative embodiment, the representations 22 comprise three payoff phrases 46a, 46b, 46c, wherein each one of the three payoff phrases 46a, 46b, 46c is for a different one of the three winning combinations 22a, 22b, 22c. Examples of the three payoff phrases 46a, 46b, 46c include “1:1,” “3:1,” and “40:1.”

When all three of the above types of representations 22 are used on the playing surface 12, it is helpful to align the representations 22 for establishing a display that permits easy understanding of where a player places the bets, and what are the winning combinations and their respective payoffs. FIG. 2 shows such an example alignment of multiple representations 22. Here, the representations 22 comprise a linear arrangement 48 of three non-intersecting rows 48a, 48b, 48c, wherein the first row 48a comprises the three circles 42a, 42b, 42c, the second row 48b comprises the three descriptive phrases 44a, 44b, 44c, and the third row 48c comprises the three payoff phrases 46a, 46b, 46c. In addition, the representations 22 comprise three groupings 50a, 50b, 50c, wherein each one of the three groupings 50a, 50b, 50c comprises a different one of the three circles 42a, 42b, 42c, a different one of the three descriptive phrases 44a, 44b, 44c, and a different one of the three payoff phrases 46a, 46b, 46c; wherein each of the groupings 50a, 50b, 50c comprises one of the three descriptive phrases 44a, 44b, 44c properly describing the one of the three payoff phrases 46a, 46b, 46c in each individual one of the three groupings 50a, 50b, 50c. In other embodiments, different alignments of multiple representations 22 will occur to those of skill in the art without departing from the scope of the invention.

Similar to the above-described types and arrangements of the representations 22, the same general discussion applies to the enlarged representations 24 of three winning combinations 22a, 22b, 22c possible from a deal of at least three cards 15. In example embodiments, the enlarged representations 24 of the three winning combinations 22a, 22b, 22c comprise “No Pair” 52a, “Pair” 52b, and “3 of a Kind” 52c, all of which are distributed within the payoff area 18. Further, the playing surface 12 also comprises three enlarged payoff phrases 54a, 54b, 54c, wherein each one of these three enlarged payoff phrases 54a, 54b, 54c is grouped with a different one of the enlarged representations 24 of the three winning combinations 22a, 22b, 22c. As an example, “No Pair” would be grouped with “1:1” and “Pairs” would be grouped with “3:1.”

In another example embodiment, the playing surface comprises indicia 36 upon the playing surface 12. Examples of indicia 36 are the licensee's identity, the establishment's identity (i.e., a casino's name), the current name of this card game, “PAIRS PLUS” or “PAIR+PLUS.” Although not specifically identified, other indicia, whether names, numbers, or symbols, will occur to those of skill in the art without departing from the scope of the invention.

In another embodiment, the apparatus 10 comprises a community card area 60 disposed upon the playing surface 12. The location of the community card area 60 is variable so long as it is visible to all players playing the card game.

In other embodiments of the invention, as shown in FIG. 1, the apparatus 10 also comprises a community card betting area 62 disposed upon the playing surface 12, and specifically the open area 16. The community card betting area 62 further comprises a plurality of player community card betting areas 64, two of which (64a, 64b, etc.) are shown in FIG. 2. Each one (64a, 64b, etc.) of the plurality of player community card betting areas 64 is located adjacent to a different one of the plurality of player betting areas 64. As such, each player has a unique player community card betting areas 64 in which to place a second-chance bet.

In further embodiments, each one (64a, 64b, etc.) of the plurality of player community card betting areas 64 also comprises a shape 65, e.g., circle, quadrilateral. Each one of these shapes 65 further comprise one or more descriptive community phrases 67 that are adjacent the shape's 65 perimeter. For example, as shown in FIG. 2, some of the one or more descriptive community phrases comprise “second chance,” “pair 1:1,” “two pair 3:1,” “three-of-a-kind 30:1,” and “four-of-a-kind 80:1.” Variations in shapes 65 and descriptive community phrases 67, and locations of the same on the playing surface 12 will occur to those of skill in the art that do not depart from the spirit of the invention.

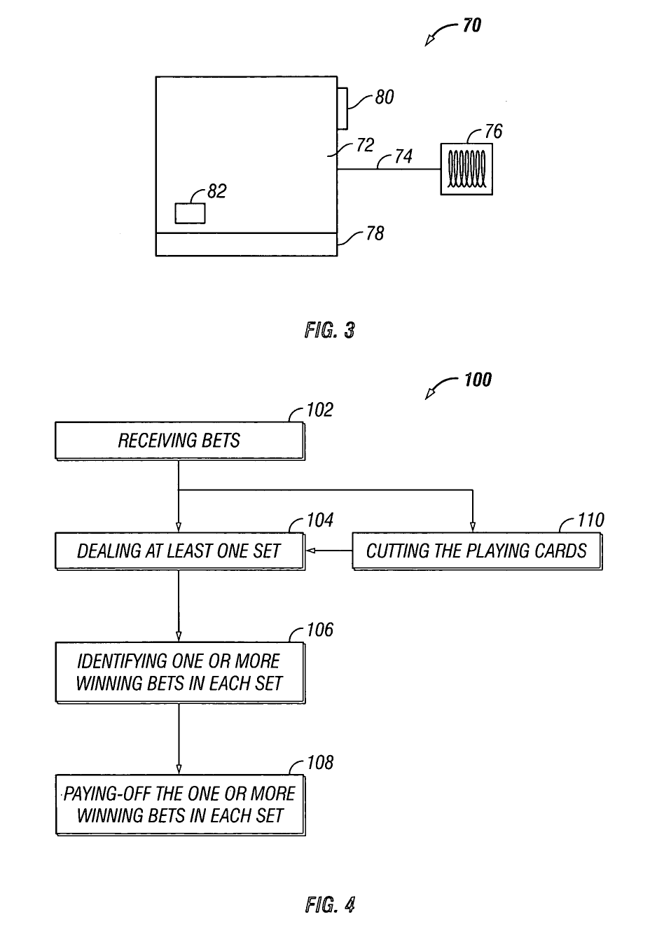

Turning to FIG. 3, another embodiment of the invention is shown. In this embodiment, the apparatus 10 comprises a computerized version 70 of the card game with a virtual playing surface 72. This computerized version 70 comprises a connection 74 to a network 76, such as the World Wide Web, in order to allow, for example, the transferring of money from an account to make bets or to the virtual playing surface 72 for paying-off bets. In addition, the computerized version 70 comprises at least one command receiver 82 for effectuating choices of a player and resultant actions by the computerized version 70. Examples of a command receiver 82 include buttons or the like for making bets, dealing virtual cards, choosing cards, requesting pay-off, and so forth. Additionally, the computerized version 70 comprises a till 78 attached to it as well as a slot 80 integrally associated with it. Those of skill in the art will recognize other advantages or features to the computerized version 70 of this apparatus 10; however, these are deemed to be within the scope of this invention.

FIG. 4 shows another aspect of the invention, a method 100 of playing a card game. The method 100 comprises receiving bets 102, dealing at least one set 104, identifying one or more winning bets in each set 106 and paying-off the one or more winning bets in each set 108.

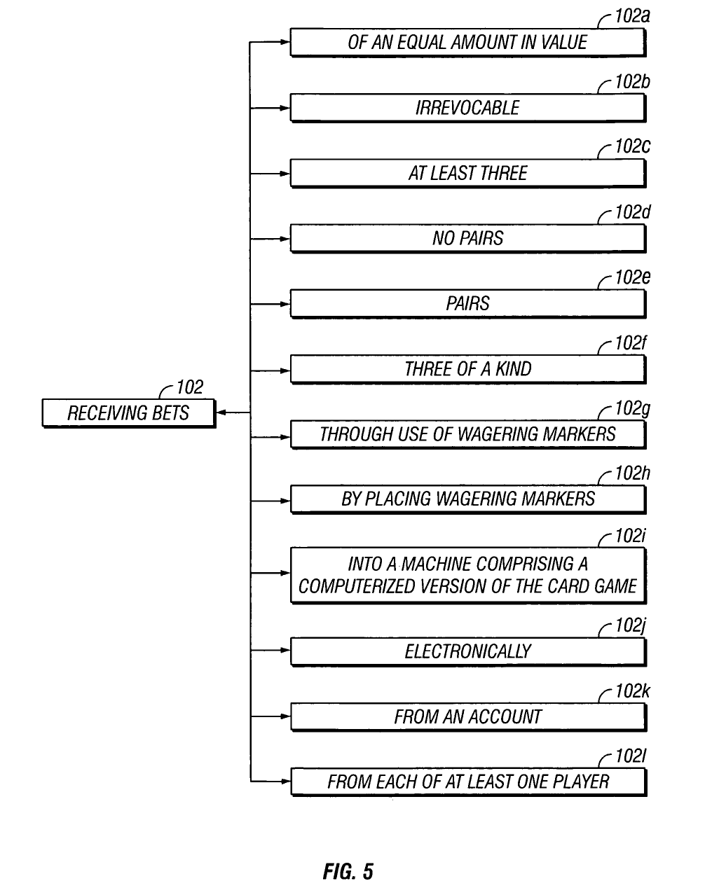

As shown in FIG. 5, the receiving bets 102 comprise various example embodiments for receiving bets. Those examples comprise receiving bets of an equal amount in value 102a, receiving irrevocable bets 102b, receiving at least three bets 102c, which are a no-pairs bet 102d, a pairs bet 102e, and a three-of-a-kind bet 102f. In addition, the method 100 comprises receiving bets 102 through use of wagering markers 102g, such as casino value chips or currency. It is customary that the receiving bets 102 is accomplished by placing wagering markers 102h on a playing surface 12 or into a slot 80.

In other examples, the method 100 comprises receiving bets 102 into a machine 102i comprising a computerized version of the card game, electronically receiving bets 102j, receiving bets from an account 102k, and receiving bets from each of at least one players 102l, which is often as many as ten or more players.

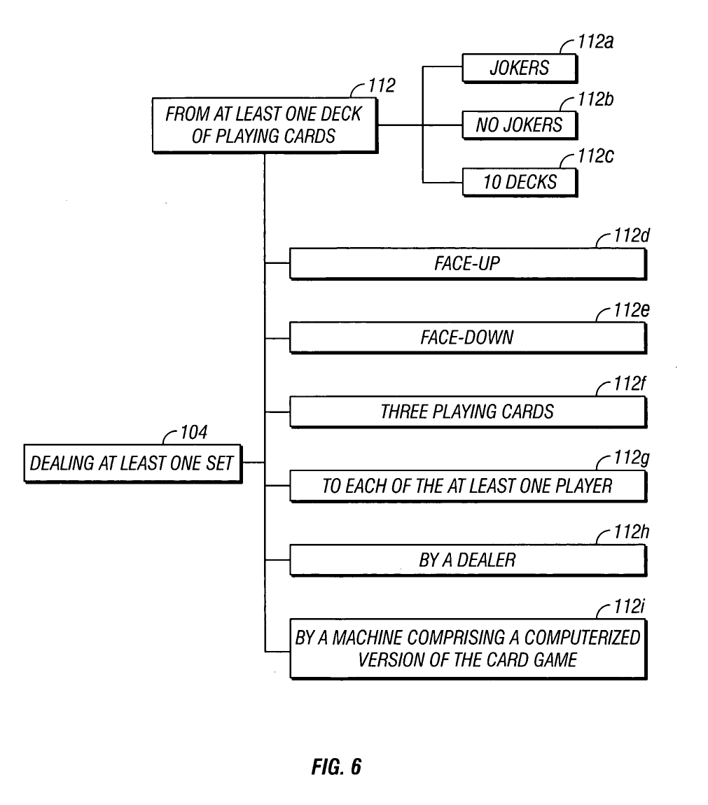

As shown in FIG. 6, the playing cards used for dealing 104 comprise from at least one deck of playing cards 112, but even ten or more decks 112c is permitted. In alternative and further example embodiments, the playing cards 112 include jokers 112a or not 112b.

In another example, as seen in FIG. 4, before dealing at least one set 104 to each player, the method 100 comprises cutting the playing cards 110.

Returning to FIG. 6, it is seen that in one embodiment, the cards 112 are dealt face-down 112e to each player, and, in another, the cards 112 are dealt face-up 112d. In still other embodiments, a dealer 112h typically performs the dealing of at least one set 104 to each of the at least one players 112g, or a player performs these actions. And, further still, the dealing 104 comprises by a machine 112i comprising a computerized version of the card game.

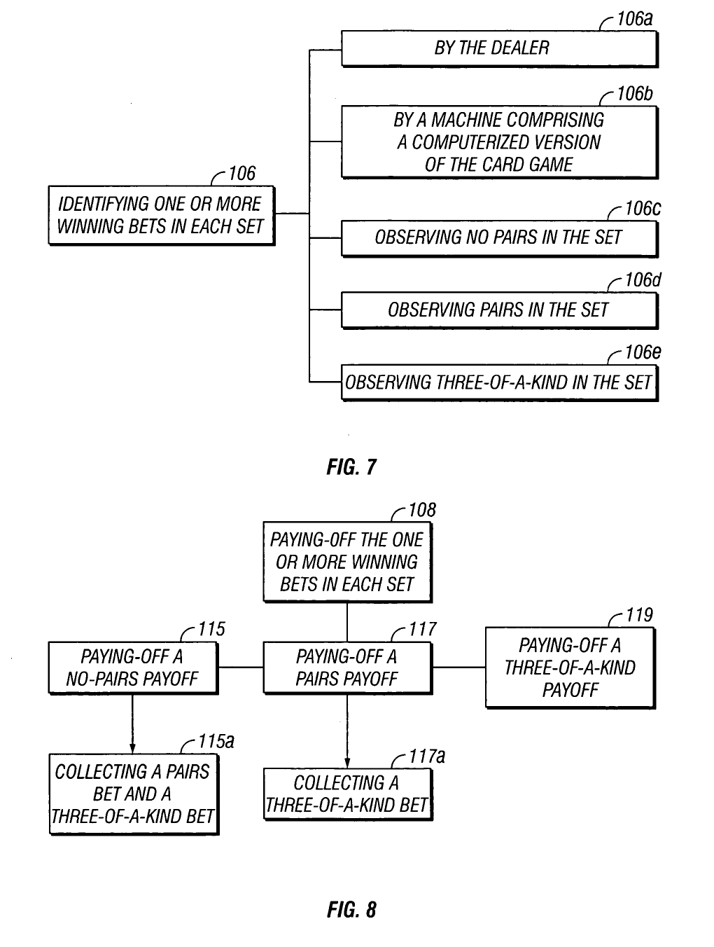

In another example embodiment, dealing the set 104 to each player comprises dealing three playing cards 112f. From these three playing cards, winning combinations are identified for each player. As seen in FIG. 7, the actual identifying of one or more winning bets in each set 106 comprises, in various example embodiments, identifying by the dealer 106a, by a machine 106b comprising a computerized version of the card game, or by another method occurring to one of ordinary skill in the art.

In various embodiments, identifying the one or more winning bets 106 comprises observing no pairs in the set 114a, observing a pair in the set 114b, and/or observing three-of-a-kind in the set 114c. Each player will have at least one of these winning combinations in their set.

Based on the winning combinations in each player's set, each player receives a pay-off for their bets. Referring to FIG. 8, in one embodiment, paying-off 108 comprises paying-off a no-pairs payoff 115 if a player has no pairs in the set belonging to the player. Typically, the no-pairs payoff 115 comprises a one-to-one payoff. In addition, if the player only has no pairs in the set, then the method 100 also comprises collecting that player's pairs bet and a three-of-a-kind bet 115a. In another embodiment, paying-off 108 comprise paying-off a pairs payoff 117 if a player has pairs in the set belonging to the player. In this instance, the pairs payoff 117 usually comprises a one-to-one payoff for a no-pairs bet and a three-to-one payoff for a pairs bet. In addition, if the player only has a pairs in the set, then the method 100 also comprises collecting a three-of-a-kind bet 117a. Finally, in yet another embodiment, paying-off 108 comprises paying-off a three-of-a-kind payoff 119 if a player has three-of-a-kind in the set belonging to the player. In this instance, the three-of-a-kind payoff typically comprises a one-to-one payoff for a no-pairs bet, a three-to-one payoff for a pairs bet, and a forty-to-one for a three-of-a-kind bet. Variations in paying-off will occur to those of ordinary skill in the art, and are deemed to fall within the scope of this invention.

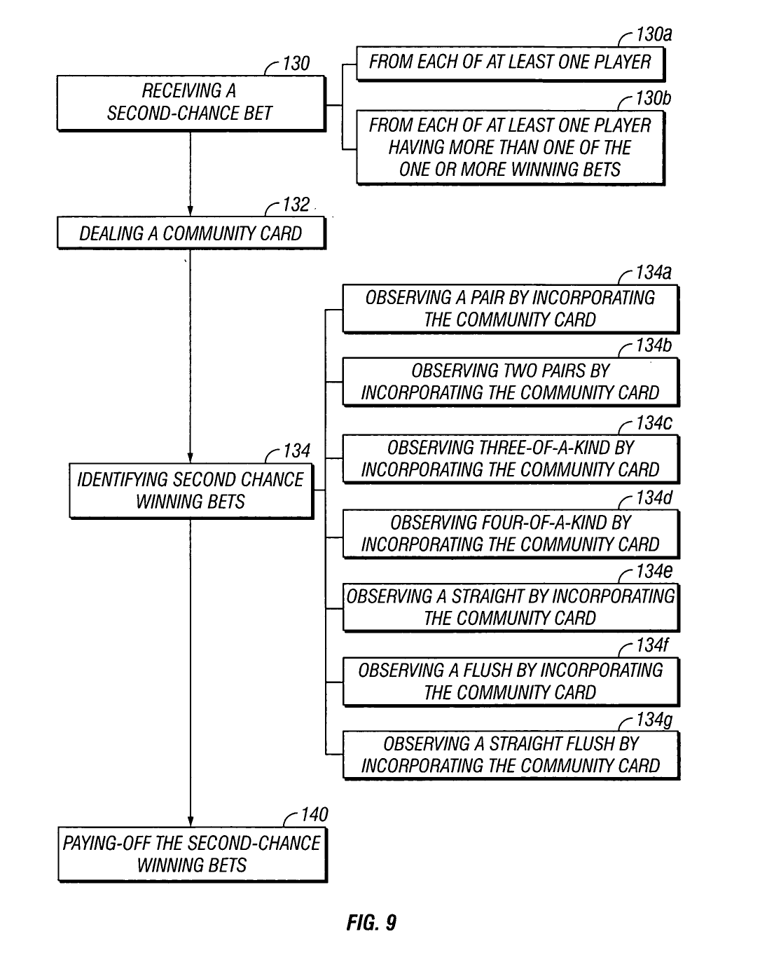

In another embodiment of this invention, the method 100 further comprises receiving a second-chance bet 130, as shown in FIG. 9. In one embodiment, receiving the second-chance bet 130 occurs before the identifying of one or more winning bets in each set 106. In another embodiment, the receiving of the second-chance bet 130 occurs after the identifying of one or more winning bets in each set 106. In still another embodiment, receiving the second-chance bet 130 occurs before the paying-off of one or more winning bets in each set 108. And, in yet another embodiment, the receiving the second-chance bet 130 occurs after the paying-off of one or more winning bets in each set 108.

Turning to receipt of the second-chance bets, the method 100 involves receiving the second-chance bet 130 from each of at least one players 130a in one embodiment. In another embodiments, the method 100 involves receiving the second-chance bet 130 from each of at least one players having more than one of the one or more winning bets 130b.

In differing embodiments, the method 100 further comprises dealing a community card 132 either before or after receiving the second-chance bets 130. Then, the method 100 comprises identifying any second-chance winning bets 134. Identifying second chance winning bets 134 comprises observing a pair by incorporating the community card 134a into the set belonging to a player. Similarly, identifying second chance winning bets 134 by inclusion of the community card includes, without limitation, observing two pairs 134b, three-of-a-kind 134c, four-of-a-kind 134d, a straight 134e, a flush 134f, or a straight flush 134g. Following the identifying of second-chance winning bets 134, the method 100 further includes paying-off the second-chance winning bets 140, if any exist.

In another embodiment, with reference to FIGS. 4-9, the method 100 comprises playing on a computerized version of the card game 150, such as on a casino gambling machine or over a network 155, e.g., the World Wide Web or a casino's intranet. In addition to receiving bets 102, dealing the set 104, and identifying one or more winning combinations 106, the method 100 comprises paying-off of the one or more winning combinations 108 to a receiving location 164, such as a local or remote account, or to a till attached or integrally associated with the computerized version of the card game. Similar to paying-off to a receiving location 164, the location of the received bets comprises a “receiving location.”

Another aspect of the invention comprises a system 200 for playing a card game. Although not discussed explicitly, the discussion regarding the method and apparatus suffice to cover the discussed means for the system's various embodiments.

The above-described embodiments should not be constructed to limit the invention to the exact details of structure described therein. Those persons skilled in this invention's field of art will readily identify modifications that are not specifically described. These modifications, however, are intended to be covered.

I claim:

1. An apparatus for a card game, the apparatus comprising:
a playing surface comprising a betting area, an open area, and a payoff area, wherein the open area is located between the betting area and the payoff area;
the betting area comprising a plurality of player betting areas, wherein each of the plurality of player betting areas further comprises representations of three winning combinations; and
the payoff area comprising enlarged representations of the three winning combinations.

2. The apparatus of claim 1, wherein the playing surface comprises the size of the top surface of a black jack table.

3. The apparatus of claim 1, wherein the playing surface further comprises a drop box attached to a side of the playing surface.

4. The apparatus of claim 1, wherein the playing surface further comprises a tip box attached to a side of the playing surface.

5. The apparatus of claim 1, wherein the representations of three winning combinations comprise the three winning combinations possible from a deal of at least three cards.

6. The apparatus of claim 1, wherein the enlarged representations of three winning combinations comprise the three winning combinations possible from a deal of at least three cards.

7. The apparatus of claim 1, wherein the betting area comprises a quasi-semi-circular arrangement.

8. The apparatus of claim 1, wherein the payoff area comprises a quasi-semi-circular arrangement.

9. The apparatus of claim 1, wherein the playing surface further comprises indicia upon the playing surface.

10. The apparatus of claim 1, wherein the representations of the three winning combinations comprise three circles, wherein each one of the three circles comprises a different one of the three winning combinations.

11. The apparatus of claim 1, wherein the representations of the three winning combinations comprise three descriptive phrases, wherein each one of the three descriptive phrases comprises a different one of the three winning combinations.

12. The apparatus of claim 1, wherein the representations of the three winning combinations comprise three payoff phrases, wherein each one of the three payoff phrases comprises for a different one of the three winning combinations.

13. The apparatus of claim 1, wherein the representations of the three winning combinations comprise three circles, three descriptive phrases, and three payoff phrases.

14. The apparatus of claim 13, wherein the representations comprise a linear arrangement of three non-intersecting rows, wherein the first row comprises the three circles, the second row comprises the three descriptive phrases, and the third row comprises the three payoff phrases.

15. The apparatus of claim 13, wherein the representations comprise three groupings, wherein each one of the three groupings comprises a different one of the three circles, a different one of the three descriptive phrases, and a different one of the three payoff phrases; wherein each of the groupings comprises one of the three descriptive phrases properly describing the one of the three payoff phrases in each individual one of the three groupings.

16. The apparatus of claim 1, wherein the enlarged representations of the three winning combinations comprise “No Pair,” “Pair,” and “3 of a Kind.”

17. The apparatus of claim 1, further comprising three enlarged payoff phrases, wherein each one of the three enlarged payoff phrases comprise groupings with a different one of the enlarged representations of the three winning combinations.

18. The apparatus of claim 1, wherein the enlarged representations comprise a distribution within the payoff area.

19. The apparatus of claim 1, further comprising a community card betting area disposed upon the open area.

20. The apparatus of claim 19, wherein the community card betting area comprises a plurality of player community card betting areas disposed upon the open area.

21. The apparatus of claim 20, wherein each of the plurality of player community card betting areas comprises a location adjacent to a different one of the plurality of player betting areas.

22. The apparatus of claim 20, wherein the shape of each of the plurality of player community card betting areas further comprises one or more descriptive community phrases adjacent to the perimeter of the shape.

23. The apparatus of claim 1, wherein the playing surface further comprises a community card area.

24. The apparatus of claim 1, wherein the apparatus comprises a computerized version of the card game.

25. The apparatus of claim 24, wherein the computerized version comprises a virtual playing surface.

26. The apparatus of claim 24, wherein the computerized version comprises a connection to a network.

27. The apparatus of claim 24, wherein a till is attached to the computerized version of the card game.

28. The apparatus of claim 24, wherein a slot is integrally associated with the computerized version of the card game.

29. The apparatus of claim 24, wherein the computerized version comprises at least one command receiver for effectuating choices of a player and resultant actions by the computerized version.

30. A method of playing a card game, the method comprising:
receiving bets;
dealing at least one set;
identifying one or more winning bets in each set; and
paying-off the one or more winning bets in each set.

31. The method of claim 30, wherein the receiving bets comprises bets of an equal amount in value.

32. The method of claim 30, wherein the receiving bets comprises receiving irrevocable bets.

33. The method of claim 30, wherein the receiving bets comprises receiving at least three bets.

34. The method of claim 30, wherein the receiving bets comprises through use of wagering markers.

35. The method of claim 30, wherein the receiving bets comprises into a machine comprising a computerized version of the card game.

36. The method of claim 30, wherein the receiving bets comprises electronically receiving bets.

37. The method of claim 30, wherein the receiving bets comprises from an account.

38. The method of claim 30, wherein the receiving bets comprises from each of at least one players.

39. The method of claim 30, wherein the dealing the set comprises from at least one deck of playing cards.

40. The method of claim 30, wherein the dealing comprises dealing face-up.

41. The method of claim 30, wherein the dealing comprises dealing face-down.

42. The method of claim 30, wherein the dealing the set comprises dealing three playing cards.

43. The method of claim 30, wherein the dealing comprises by a machine comprising a computerized version of the card game.

44. The method of claim 30, wherein the identifying comprises by a dealer.

45. The method of claim 30, wherein the identifying comprises by a machine comprising a computerized version of the card game.

46. The method of claim 30, wherein the identifying one or more winning bets comprises observing no pairs in the set.

47. The method of claim 30, wherein the identifying one or more winning bets comprises observing a pair in the set.

48. The method of claim 30, wherein the identifying one or more winning bets comprises observing three-of-a-kind in the set.

49. The method of claim 30, wherein the paying-off comprises paying-off a no-pairs payoff if a player has no pairs in the set belonging to the player.

50. The method of claim 49, further comprising collecting a pairs bet and a three-of-a-kind bet.

51. The method of claim 30, wherein the paying-off comprises paying-off a pairs payoff if a player has pairs in the set belonging to the player.

52. The method of claim 51, further comprising collecting a three-of-a-kind bet.

53. The method of claim 30, wherein the paying-off comprises paying-off a three-of-a-kind payoff if a player has three-of-a-kind in the set belonging to the player.

54. The method of claim 30, further comprising receiving a second-chance bet.

55. The method of claim 54, wherein the receiving a second-chance bet comprises from each of at least one players.

56. The method of claim 54, wherein the receiving a second-chance bet comprises from each of at least one players having more than one of the one or more winning bets.

57. The method of claim 54, further comprising dealing a community card.

58. The method of claim 54, further comprising identifying second-chance winning bets.

59. The method of claim 58, wherein the identifying second-chance winning bets comprises observing by incorporating the community card into the set belonging to a player.

60. The method of claim 54, further comprising paying-off the second-chance winning bets.

61. The method of claim 30, wherein the method of playing comprises playing on a computerized version of the card game.

62. The method of claim 61, wherein the computerized version comprises a casino gambling machine.

63. The method of claim 61, wherein the computerized version comprises playing over a network.

64. The method of claim 61, wherein the receiving comprises receiving on the computerized version of the card game.

65. The method of claim 61, wherein the identifying comprises identifying on the computerized version of the card game.

66. The method of claim 30, wherein the paying-off comprises paying-off to a receiving location.

67. A system for playing a card game, the system comprising:
means for receiving bets;
means for dealing at least one set;
means for identifying one or more winning bets in each set; and
means for paying-off the one or more winning bets in each set.

68. The system for claim 67, wherein the means for receiving bets comprises bets of an equal amount in value.

69. The system for claim 67, wherein the means for receiving bets comprises receiving irrevocable bets.

70. The system for claim 67, wherein the means for receiving bets comprises receiving at least three bets.

71. The system for claim 67, wherein the means for receiving bets comprises through use of wagering markers.

72. The system for claim 67, wherein the means for receiving bets comprises into a machine comprising a computerized version of the card game.

73. The system for claim 67, wherein the means for receiving bets comprises means for electronically receiving bets.

74. The system for claim 67, wherein the means for receiving bets comprises from an account.

75. The system for claim 67, wherein the means for receiving bets comprises from each of at least one players.

76. The system for claim 67, wherein the dealing the set comprises from at least one deck of playing cards.

77. The system for claim 67, wherein the dealing comprises dealing face-up.

78. The system for claim 67, wherein the dealing comprises dealing face-down.

79. The system for claim 67, wherein the means for dealing the set comprises means for dealing three playing cards.

80. The system for claim 67, wherein the means for dealing comprises by a machine comprising a computerized version of the card game.

81. The system for claim 67, wherein the means for identifying comprises by a dealer.

82. The system for claim 67, wherein the means for identifying comprises by a machine comprising a computerized version of the card game.

83. The system for claim 67, wherein the means for identifying one or more winning bets comprises means for observing no pairs in the set.

84. The system for claim 67, wherein the means for identifying one or more winning bets comprises means for observing a pair in the set.

85. The system for claim 67, wherein the means for identifying one or more winning bets comprises means for observing three-of-a-kind in the set.

86. The system for claim 67, wherein the means for paying-off comprises means for paying-off a no-pairs payoff if a player has no pairs in the set belonging to the player.

87. The system for claim 86, further comprising means for collecting a pairs bet and a three-of-a-kind bet.

88. The system for claim 67, wherein the means for paying-off comprises means for paying-off a pairs payoff if a player has pairs in the set belonging to the player.

89. The system for claim 88, further comprising means for collecting a three-of-a-kind bet.

90. The system for claim 67, wherein the means for paying-off comprises means for paying-off a three-of-a-kind payoff if a player has three-of-a-kind in the set belonging to the player.

91. The system for claim 67, further comprising means for receiving a second-chance bet.

92. The system for claim 91, wherein the means for receiving a second-chance bet comprises from each of at least one players.

93. The system for claim 91, wherein the means for receiving a second-chance bet comprises from each of at least one players having more than one of the one or more winning bets.

94. The system for claim 91, further comprising means for dealing a community card.

95. The system for claim 91, further comprising means for identifying second-chance winning bets.

96. The system for claim 95, wherein the means for identifying second-chance winning bets comprises means for observing by incorporating the community card into the set belonging to a player.

97. The system for claim 91, further comprising means for paying-off the second-chance winning bets.

98. The system for claim 67, wherein the system for playing comprises means for playing on a computerized version of the card game.

99. The system for claim 98, wherein the computerized version comprises a casino gambling machine.

100. The system for claim 98, wherein the computerized version comprises means for playing over a network.

101. The system for claim 98, wherein the means for receiving comprises means for receiving on the computerized version of the card game.

102. The system for claim 98, wherein the means for identifying comprises means for identifying on the computerized version of the card game.

103. The system for claim 67, wherein the means for paying-off comprises means for paying-off to a receiving location.
